(19) United States
(12) Patent Application Publication
(10) Pub. No.: US 2006/0182242 A1
(43) Pub. Date: Aug. 17, 2006

(54) Method and device for obtaining data related to the presence and/or availability of a user

(75) Inventors: Katell Henry, Pleumeur Bodou (FR); Olivier Roussel, Pleumeur Bodou (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: France Telecom, Paris (FR)

(21) Appl. No.: 11/331,837

(22) Filed: Jan. 13, 2006

(30) Foreign Application Priority Data
Jan. 14, 2005 (FR) 05/00435

(51) Int. Cl. H04M 15/00

(52) U.S. Cl. 379/114.01

(57) ABSTRACT

A method is provided, which includes a configuration phase that includes a stage for saving the first data multiplets each associated with a user identity, an expression composed of at least one word and at least one presence and/or availability data element. It also includes a usage phase that includes the following stages, when a given user pronounces an expression: obtaining, using voice recognition, the identity of the given user and the expression pronounced by the given user; identifying the data multiplet that includes the identity of the given user and the expression pronounced by the given user; reading said presence and/or availability data element included in the identified first multiplet, in order to obtain at least one current presence and/or availability data element for the given user.

### FIELD OF DISCLOSURE

The disclosure relates to a method and device for obtaining the data related to the presence and/or availability of a user.

The domain of this disclosure is that of techniques that allow acquiring and providing data related to the presence and/or availability of users to presence data management devices. The disclosure is notably, but not exclusively, applicable to the supply of presence and/or availability data to a presence data management device embedded on a residential gateway or on a multiservice modem/router (also called “home gateway”), or integrated into the server of a communication network operator (for example, a telephone operator) or into the server of an Internet Service Provider.

### BACKGROUND OF THE DISCLOSURE

Currently, more and more residential subscribers have a residential gateway or multiservice modem/router, of the type LiveBox (trademark) or Freebox (trademark) in their homes which allows them to access new services such as fast-speed Internet, telephone and television-over-IP (Internet Protocol) services. These telephone-over-IP services allow service providers to offer, among other things, the users the possibility of tailoring services that are provided to them according to the data related to the presence and/or availability of this user in his home. This assumes that the user declares a presence status, for example “user absent” or “user busy”, to a presence data management device. This presence data management device can be either integrated into the residential gateway or into the multiservice modem/router, or remote, connected through a communication network.

Currently, devices allowing users to announce their presence data are software programs installed on computers, personal digital assistants (PDA,) mobile telephones, etc. This way, users place presence information in a declarative manner on their terminal, PC, PDA, or cellular phone. This presence declaration is performed using a communication terminal connected via a link, either wired or wireless to the IP network towards the server that is also located on the IP network. This terminal, for example, is a laptop or personal computer, a PDA, and the links to the IP network can be an Ethernet, WiFi (Wireless Fidelity) Bluetooth, GPRS, or UMTS type link. For this purpose, this communication terminal includes software that allows entering and transmitting to the presence management server the data related to the presence of the user, according to a predetermined communication protocol.

This presence data acquisition method is well adapted in the case of users that are familiar with computers. Nevertheless, for other users, there are a number of disadvantages. Indeed, the interface of the known method is limited by the fact that users must first launch a software program integrated into the communication terminal, then manually enter using a digital keypad, that tends to be small, an identifier and a password; and then, if necessary, navigate in a menu to select and click the icon corresponding to their presence status.

The selection menu is displayed on the communication terminal screen, which is generally very small, thus forcing users to hold the communication terminal in their hand and hold the screen right in front of them in order to be able to distinguish the various icons. In addition, it is also normally necessary to have adequate lighting, in particular when dealing with LCD screens.

Regardless of the type of user, either accustomed to computers or afraid of computers, such a method requires at least entering data using an alphanumeric keypad, which is time consuming and limiting.

Additionally, and in particular for the reasons expressed above, this presence data acquisition method is incorrectly adapted to children, housewives whose arms are full of groceries, people with reduced mobility, people with hand or sight disabilities, etc.

Furthermore, this method does not allow offering the management of the presence and/or availability on more traditional telephones, that only include an alphanumeric keypad, with small screens and without operating systems that allow launching software applications. This is the case of most traditional DECT (Digital Enhanced Cordless Telephone) type telephones currently used in most French households.

### SUMMARY

An embodiment of the invention is directed to a method for obtaining data related to the presence and/or availability of a least one user. According to the embodiment, such a method advantageously includes:
a configuration phase that includes a stage for saving the first data multiplets, each of which is associated to a user identity, an expression composed of at least one word, and at least one presence and/or availability data element;
a usage phase that includes the following stages, when a given user pronounces an expression:
obtaining, using voice recognition, the identity of the given user and the expression pronounced by the given user;
from among the first saved data multiplets, identifying the multiplet that includes the identity of the given user and the expression pronounced by the given user;
reading of said first presence and/or availability data element included in the first identified multiplet, in order to obtain at least one current presence and/or availability data element for the given user.

Thus, one or more embodiments of the invention are based on a completely new and inventive approach to acquiring data related to a presence and/or availability of a user. Indeed, an embodiment of the invention is based on voice recognition, which therefore does not require any specific manual action by the user. It is important to note that the technique is secure by the fact that the presence and/or availability status of a given user can only be modified by said given user. Indeed, this modification is conditioned by the fact that the user is identified by the characteristics of his voice (tone, voice intonation, etc.) that the pronounced. expression is recognised, and lastly, that there is a pre-recorded data multiplet that contains this user identifier and this expression. According to an embodiment of the invention, the user has pre-recorded, for example, in a data table, the first multiplets of data each related to a user ID, an expression, and at least one presence and/or availability data element. In a specific case, the data multiplet is a data triplet when it contains a user ID, an expression, and a presence and/or availability data element. Furthermore, the expression pronounced by the user can be composed of one or several vocal elements such as, for example, a letter, a word, a phrase, an onomatopoeia, etc.

Advantageously, the user can associate a presence and/or availability data element to each vocal element of an expression, in order to obtain a data multiplet that allows defining a more precise service configuration. It should be noted that such a data multiplet can also include a data element related to a bell.

Preferably, each multiplet includes a first and at least a second presence and/or availability data element; said first presence and/or availability data element is a general data element related to the presence and/or availability of said user, and said second presence and/or availability data element is a filter data element that allows limiting the use of the first presence and/or availability data element to at least one group of callers that includes at least one determined caller.

A group of callers is, for example, a sum of identifies based principally on telephone numbers. Such a group can be defined in a data table that is different than the table containing the fist data multiplets. Optionally, the second presence and/or availability data element allows automatically associating a presence data element (for example, “present”) to a group, and another presence data element (for example, “absent”) to another group.

Advantageously, the method additionally includes a transmission phase of said at least one current presence and/or availability data element to at least one presence data management device.

In a preferred embodiment of the invention, the method is implemented in a residential gateway or in a multiservice modem/router; the data management device(s) is(are) placed in said residential gateway or said multiservice modem/router and/or in a server linked to said residential gateway or said multiservice modem/router through a communication network.

Advantageously, the stage for obtaining, using voice recognition, the identity of the given user is based on a technique of recognising the voice tone of the given user.

Preferably, the presence and/or availability data elements included in the first data multiplets belong to a group that includes:
“user present and available”;
“user absent”;
“user present but unavailable.”

Absent means any type of absence by the user. For example, because the user is away from home, away from his usual residence or from the location where he should be found (user has gone shopping, is in a meeting, etc.)

According to an advantageous aspect of an embodiment of the invention, said configuration phase also includes a stage for saving second data multiplets associating each a user identity, an expression, and at least one action, and said usage phase also includes the following stages, when a given user pronounces an expression:
obtaining, using voice recognition, the identity of the given user and the expression pronounced by the given user;
from among the second saved data multiplets, identifying the multiplet that includes the identity of the given user and the expression pronounced by the given user;
executing said at least one action included in the second identified multiplet.

Preferably, the actions included in the second data multiplets belong to the group that includes:
“providing current presence and/or availability data for the given user and/or for at least one other determined user;”
“providing a list of expressions that include expression already saved and/or available expressions for the given user and/or at least one other determined user.”

Advantageously, each of the data multiplets includes a distinct expression.

An embodiment of the invention also relates to a computer program product that includes program code instructions for running the stages of the above-mentioned method, when said program is running on a computer.

A computer is any machine that includes at least one processing unit equipped with a microprocessor, such as a residential gateway or multiservice modem/router.

An embodiment of the invention also relates to a storage means, which may be fully or partially removable, computer readable, and storing a set of instructions that can be executed by said computer in order to implement the above-mentioned method.

Additionally, an embodiment of the invention relates to a device for obtaining data related to the presence and/or availability of at least one user that includes:
means for saving first data multiplets associating each one with a user identity, an expression composed of at least one word and at least one presence and/or availability data element;
means for obtaining, using voice recognition, the identity of a given user that has pronounced an expression and the expression pronounced by said given user;
means for identifying, from among the first saved data multiplets, the multiplet that includes the identity of the given user and the expression pronounced by the given user;
means for reading said at least one presence and/or availability data element included in the first identified multiplet, in order to obtain for the given user at least one current presence and/or availability data element that is current.

Preferably, the device also includes means for transmitting said at least one presence and/or availability data element to at least one presence data management device.

Advantageously, the device is included in a residential gateway or in a multiservice modem/router, the presence data mangement device(s) being implemented in said residential gateway or said multuservice modem/router and/or in a server linked to said residential gateway or to said multiservice modem/router through a communication network.

Preferably, the device also includes:
means for saving second data multiplets associating each one with a user identity, an expression, and at least one action;
means for identifying, from among the second saved data multiplets, the multiplet that includes the identity of the given user and the expression pronounced by the given user;
means for running said at least one action included in the second identified multiplet.

An embodiment of the invention also relates to a communications terminal that includes the above-mentioned device for obtaining data.

Other characteristics and advantages of one or more embodiments of the invention will become more evident by reading the following descriptions of a preferred embodiment, given as a non-limiting example, and the attached figures.

### BRIEF DESCRIPTION OF THE DRAWINGS

FIG. 1 illustrates a first embodiment of the device for obtaining data according to a first embodiment of the invention, when it is included in a residential gateway or in a multiservice modem/router and transmits these data to a presence data management device that is also included in this residential gateway or multiservice modem/router.

FIG. 2 illustrates a second embodiment of the device for obtaining data, when it is included in a residential gateway and/or multiservice modem/router and transmits these data to a remote presence and/or availability data management device, connected to the multiservice modem/router or the residential gateway through a communication network.

FIG. 3 represents a flowchart of a specific embodiment of the method for obtaining data according to an embodiment of the invention.

FIG. 4 presents an example of a data table according to an embodiment of the invention, in which the data triplets are saved.

FIG. 5 presents an example of a data table according to an embodiment of the invention, in which the presence data corresponding to the calling groups are saved.

FIG. 6 presents the structure of a specific embodiment of a device for obtaining presence and/or availability data according to the invention.

### DETAILED DESCRIPTION OF ILLUSTRATIVE EMBODIMENTS

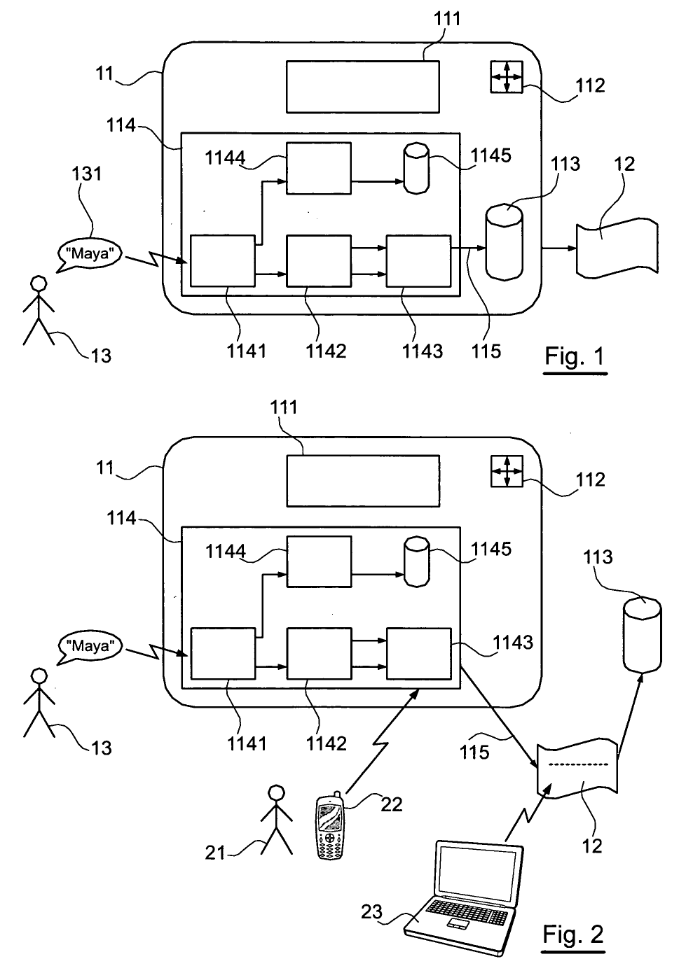

One or more embodiments of the invention provide a technique for obtaining data related to the presence and/or availability of a user. In the following description, it is assumed for the example that the device for obtaining data according to an embodiment of the invention is included in a multiservice modem/router or in a residential gateway (for example “LiveBox” by Wanadoo) and transmits the data obtained to a presence and/or availability data management device that is also included in this multiservice residential (FIG. 1) or remote equipment (FIG. 2.)

As can be noted, on all the figures of this document, the identical elements are designated using the same numerical reference.

In order to simplify the description, what follows in this document will be limited to describing the specific case of a data multiplet (also called data triplet) that only contains one user identity, one expression, and one presence and/or availability data element, or one action to perform.

FIG. 1 illustrates a first embodiment of the invention. A traditional residential multiservice modem/router 11 that include, in particular, a screen 111, for example, an LCD type screen that allows presenting the number of the calling line, the name of the caller or other information related to the querying of the presence and/or availability status of the person that queries it; selection keys 112; and a presence and/or availability data management device 113. This residential multiservice modem/router 11 is connected to a carrier network 12, for example an STN (Switched Telephone Network.)

According to an embodiment of the invention, this residential multiservice modem/router 11 is equipped with a device for obtaining presence and/or availability data 114 that includes means for receiving audio data 1141, for example, a microphone; means for processing the audio data received 1142; means for reading the presence and/or availability data 1143; means for saving the data triplets 1144; and means for storing the data triplets 1145 (also called data table.)

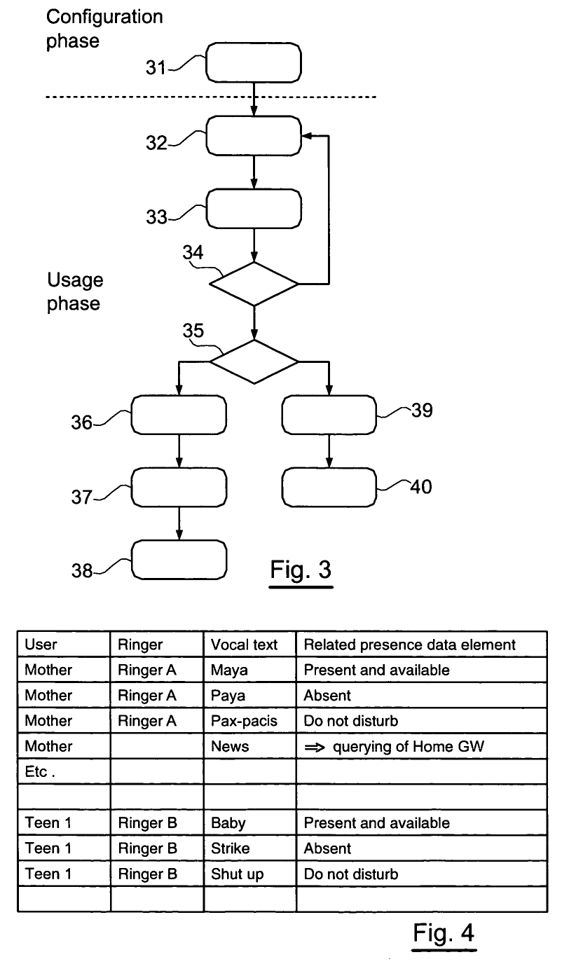

As will be evident in relation to FIG. 3, the method for obtaining presence and/or availability data according to a preferred embodiment of the invention advantageously includes, before being used, an initialisation stage that consists in saving the data triplets in the data table.

In this first embodiment, the data triplets are saved using reception means 1141. For this purpose, one or several users 13 (for example, the members of a family) each pronounce, in the following order, a user identity, an expression (for example, one or several words or onomatopies,) and a presence information or specific action to be carried out (for example, providing the current presence status.) In particular, each user can choose X keyword(s) or expression(s) that they will associate to presence information or a specific action. Keywords or expressions can be specific to each user, which allows further reducing error sources.

This audio data is then transmitted to the saving means 1144, which verify the validity of each triplet (for example, if the data triplet correctly includes three data elements) before they are saved in a data table 1145.

In a first embodiment, as illustrated in FIG. 4, the data table is composed of four columns, where the first, third, and fourth columns contain the user identity, the pronounced expression and the presence data or action to be performed (that is, the above-mentioned data triplets), respectively. The second column in the data table contains the personal ring data of each user. It should be noted that the ring data can be defined in a data table that is different from the table that contains the first above-mentioned data multiplets.

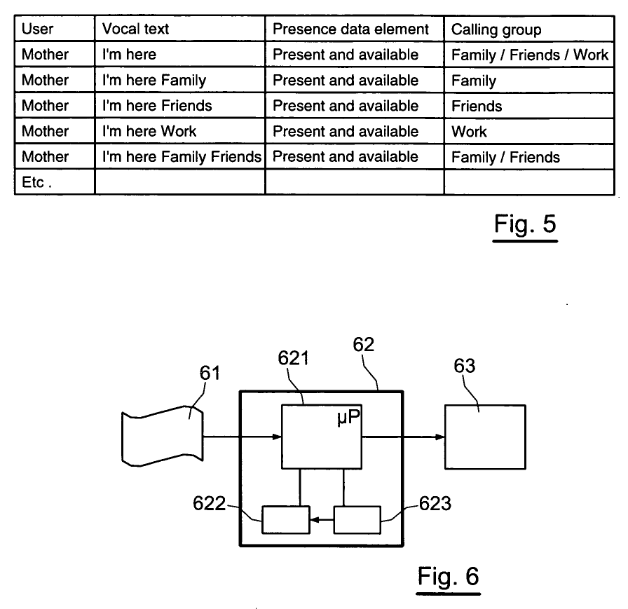

In a second embodiment, as illustrated in FIG. 5, the data table is composed of four columns, where the first, second, third, fourth columns contain the user identity, the pronounced expression, the presence data element or action to be performed and the related calling group, respectively. The use of the fourth column is optional and the expression “I am here” only correspond by default to the “all” group; that is, all incoming calls are accepted. For example, when the user pronounces the expression “I am here Family,” the vocal element “I am here” is associated to the presence data element “presence and available” and the “Family” vocal element defines the calling group for which this presence data element is applicable. Optionally, when the user pronounces the expression “I am here Family,” the other calling groups “Friends” and “Work” are associated to the presence data element “absent”.

In a variant of the embodiment, the data triplets can also be saved using the selection keys 112 and reception means 1141.

When used, the reception means 1141 will allow remotely acquiring a keyword or expression 131 pronounced by a user 13 present in his home. The processing means 1142, in turn, will allow knowing the identity of the user 13, for example, from the tone of the user's voice, and extracting the expression 131 from the ambient noise. These voice recognition processing techniques are well known to those skilled in the art and therefore are not described in detail in this document. Lastly, the reading means 1143 will allow searching for and reading, in the data table 1145, the presence data associated with the expression 131. This presence data element 115 is transmitted to the presence data management device 113, based on a predetermined communication protocol. Thus, such a method according to an embodiment of the invention allows a user to define a presence status, for example, “user absent” or “user busy” so that when there is an incoming call, and depending on the chosen presence status, the presence data management device accepts the call or rejects it.

As illustrated in FIG. 2, the presence data management device 113 can be connected to the residential gateway or to the multiservice modem/router 11 through a communication network 12. In this second embodiment, the presence data 115 is transmitted to a presence data management device 113 through the communication network 12, based on a predetermined communication protocol. Such a method according to an embodiment of the invention also allows a user 21 that loses his voice (alteration of the user's voice) or that has forgotten to specify his presence data before leaving his home, to define it using a communication terminal 22, 23 connected to the presence data management device 113 from a remote site (affiliate network or using a wireless connection, for example, an IP or GSM type connection) and for example through a Web interface if the integrated presence and/or availability management server has a Web server.

Other types of implementations can of course be foreseen, for example, the functionality of an embodiment of the invention can be ensured using an additional box (not represented) that is used in conjunction with the residential gateway or the multiservice modem/router 11. This additional box (not represented) can, for example, be connected using a wire link (i.e. USB type link), or a wireless link (i.e. a Bluetooth link).

It is presented, in relation to FIG. 3, a specific embodiment of the method for obtaining data that allows a user to specify a presence status to a presence data management device.

A configuration phase includes a first stage 31 during which the user saves, into the data table 1145, first data triplets associating each a user identity, an expression, and a presence and/or availability data element, and second data triplets associating each a user identity, an expression, and an action to be performed. During this stage, the information dictated by the user is captured using reception means 1141. The data triplets can be completed using information related to the specific ringer for each user (see FIG. 4.)

It should be noted that these triplets can be completed or modified as desired at any time by the user throughout the live of the product using these reception means.

The following stages are related to a usage phase.

During the following stage 32, the reception means 1141 detect any user vocal activity.

During stage 33, the user's vocal activity is processed by processing means 1142 in order to verify, on the one hand, the identity of the user from the user's voice characteristics (tone of voice, etc.) and, on the other hand, whether the user has pronounced a keyword or expression, which he has previously saved into the data table.

If the data pair formed by the voice tone and the expression pronounced by the user is not valid (because it has not been saved in the data table) the process returns to stage 32, otherwise, it moves to stage 35.

During this stage 35, it is determined whether the user has pronounced an expression, which belongs to a first or second data triplet. If the expression belongs to a first triplet, the process moves to stage 36, otherwise it moves to stage 39.

During stage 36, the reading means 1143 read the data table in order to extract, based on the data pair that includes the user identity and the pronounced expression, the pre-saved data element related to the user presence.

Then, during stage 37, this data element related to the presence of the user is formatted according to an instant messaging protocol, for example, XMPP, SIMPLE, etc., that is compatible with the presence data management device.

Lastly, during stage 38, the data element related to the presence of the user is transmitted to the presence data management device, based on a predetermined communication protocol.

During stage 39, the reading means 1143 read the data table in order to extract, based on the data pair that includes the user identity and the pronounced expression, the pre-saved action to be executed.

During stage 40, the device for obtaining the presence data 114 runs the action requested by the user.

Advantageously, an embodiment of the invention allows to display the data (last presence data element, list of expressions) requested by the user on the LCD screen of the multiservice modem/router or use a speaker in order to output them.

Lastly, FIG. 6 illustrates the structure of a device for obtaining the presence and/or availability data 62 according to an embodiment of the invention, which includes a memory 662 and a processing unit 621 equipped with a microprocessor μP, which is controlled by a computer program (or application) 623. The processing unit 621 receives on its input an expression 61 pronounced by a user or manually entered by the user through a man-machine interface (for example, an alphanumeric keypad.) The microprocessor μP processes this expression based on the program instructions 623 in order to generate the presence and/or availability data that are transmitted to a presence management server 63.

To summarise, the method and device for obtaining data related to the presence and/or availability of at least one user, such as those suggested by one or more embodiments of the invention, have several advantages, a non-exhaustive list of which is given below:
Improvement of the interface for specifying a presence status. Indeed, an embodiment of the invention allows a user to easily and efficiently define the data related to a presence and/or availability status without having to hold the communication terminal or handle a keypad or a mouse. The embodiment therefore is of particular interest to people with mobility difficulties or those that suffer hand disabilities.
Improvement of the security of the personal information saved in the residential gateway or multiservice modem/router by a given user. Indeed, an embodiment of the invention is based on identifying the tone of voice of a user.

One or more embodiments of the invention thus overcome disadvantages of the previous art. More specifically, one or more embodiments provide a technique that allows users to easily and efficiently define this data related to the presence and/or availability, without needing to launch a computer type terminal, or portable device, or perform any type of specific manipulation.

At least one embodiment allows users to comfortably and quickly know the last presence status that they have configured (current presence status.)

One or more embodiments provide such a technique that it is ergonomic and eliminates, or at least limits, operations that users need to perform.

One or more embodiments provide such a technique that it is particularly correctly tailored to people with reduced mobility, or people with hand or sight disabilities.

Further, one or more embodiments provide such a technique that it is easy and economic to implement.

Although the present invention has been described with reference to one or more embodiments, workers skilled in the art will recognize that changes may be made in form and detail without departing from the spirit and scope of the invention.

What is claimed is:

1. Method for obtaining data related to the presence and/or availability of at least one user, wherein the method includes:
a configuration phase that includes a stage for saving first data multiplets, each of which is associated to a user identity, an expression composed of at least one word, and at least one presence and/or availability data element; and
a usage phase that includes the following stages, when a given user pronounces an expression:
obtaining, using voice recognition, the user identity of the given user and the expression pronounced by the given user;
from among the saved first data multiplets, identifying the first data multiplet that includes the user identity of the given user and the expression pronounced by the given user; and
reading of said presence and/or availability data element included in the identified first data multiplet, in order to obtain at least one current presence and/or availability data element for the given user.

2. Method according to claim 1, wherein each multiplet includes a first and at least a second presence and/or availability data element, and wherein:
said first presence and/or availability data element is a general data element related to the presence and/or availability of said user; and
said second presence and/or availability data element is a filter data element that allows limiting the use of the first presence and/or availability data element to at least one group of callers that includes at least one determined caller.

3. Method according to claim 1, wherein the method also includes a transmission stage of said at least one current presence and/or availability data element to at least one presence data management device.

4. Method according to claim 3, wherein the method is also implemented in a residential gateway or in a multiservice modem/router and the data management device is placed in said residential gateway or said multiservice modem/router and/or in a server linked to said residential gateway or said multiservice modem/router through a communication network.

5. Method according to claim 1, wherein the stage for obtaining, using voice recognition, the identity of the given user is based on a technique of recognising the voice tone of the given user.

6. Method according to claim 1, wherein the presence and/or availability data elements included in the first data multiplets belong to a group that includes:
“user present and available”;
“user absent”; and
“user present but unavailable”.

7. Method according to claim 1, wherein said configuration phase also includes a stage for saving second data multiplets, each of which associating a user identity, an expression, and at least one action, and wherein said usage phase also includes the following stages, when a given user pronounces an expression:
obtaining, using voice recognition, the identity of the given user and the expression pronounced by the given user;
from among the saved second data multiplets, identifying the multiplet that includes the identity of the given user and the expression pronounced by the given user;
executing said at least one action included in the second identified multiplet.

8. Method according to claim 7, wherein the actions included in the second data multiplets belong to the group that includes:
providing current presence and/or availability data for the given user and/or for at least one other determined user; and
providing a list of expressions that include the expression already saved and/or available expressions for the given user and/or at least one other determined user.

9. Method according to claim 1, wherein each of the first data multiplets includes a distinct expression.

10. A computer program product, which includes program code instructions for running the stages of the method according to claim 1, when the program code is running on a computer.

11. Storage means, which is fully or partially removable and computer readable, and which stores a set of instructions that can be executed by said computer in order to implement the method according to claim 1.

12. Device for obtaining data related to the presence and/or availability of at least one user, wherein the device includes:
means for saving first data multiplets associating each one with a user identity, an expression composed of at least one word and at least one presence and/or availability data element;
means for obtaining, using voice recognition, the identity of a given user that has pronounced an expression and the expression pronounced by said given user;
means for identifying, from among the saved first data multiplets, the multiplet that includes the identity of the given user and the expression pronounced by the given user;
means for reading said at least one presence and/or availability data element included in the identified first data multiplet, in order to obtain for the given user at least one current presence and/or availability data element.

13. Device according to claim 12, wherein the device also includes means for transmitting said at least one presence and/or availability data element to at least one presence data management device.

14. Device according to claim 13, wherein the device is included in a residential gateway or in a multiservice modem/router and the presence data management device is in said residential gateway or said multiservice modem/router and/or in a server linked to said residential gateway or to said multiservice modem/router through a communication network.

15. Device according to claim 12, wherein the device also includes:
means for saving second data multiplets associating each one with a user identity, an expression, and at least one action;
means for identifying, from among the saved second data multiplets, the multiplet that includes the identity of the given user and the expression pronounced by the given user;
means for running said at least one action included in the identified second data multiplet.

16. Communication terminal comprising a device for obtaining data according to claim 12.
